(19) United States
(12) Patent Application Publication
(10) Pub. No.: US 2008/0272630 A1
(43) Pub. Date: Nov. 6, 2008

(54) SEAT ASSEMBLY HAVING A REMOVABLE LOAD FLOOR PANEL

(75) Inventors: Alan Sturt, West Bloomfield, MI (US); Christopher Jones, Southfield, MI (US); Roger Knutson, Sterling Heights, MI (US)

Correspondence Address: BROOKS KUSHMAN P.C.;INTL. AUTOMOTIVE COMPONENTS GROUP, 1000 TOWN CENTER, TWENTY-SECOND FLOOR, SOUTHFIELD, MI, 48075, US

(73) Assignee: INTERNATIONAL AUTOMOTIVE COMPONENTS GROUP NORTH AMERICA, INC., Dearborn, MI (US)

(21) Appl. No.: 11/743,272

(22) Filed: May 2, 2007

(51) Int. Cl. B60N 2/32; B60N 2/00; B60N 2/44

(52) U.S. Cl. 297/188.07; 297/188.01

(57) ABSTRACT

A vehicle seat assembly having a seat back and a load floor panel associated with the seat assembly. The seat back has a back surface that includes a first retaining feature. The load floor panel has a first attachment feature. The first retaining feature engages the first attachment feature when the load floor panel is in a stored position. The load floor panel is detached from the seat assembly when the load floor panel is in a cover position.

### BACKGROUND OF THE INVENTION

### Field of the Invention

The present invention relates to a seat assembly having a removable load floor panel.

### SUMMARY OF THE INVENTION

In at least one embodiment of the present invention a vehicle seat assembly is provided. The vehicle seat assembly includes a seat back. A load floor panel is associated with the seat assembly. The seat back has a back surface that includes a first retaining feature. The load floor panel has a first attachment feature. The first retaining feature engages the first attachment feature when the load floor panel is in a stored position. The load floor panel is detached and spaced apart from the seat assembly when the load floor panel is in a cover position.

In at least one other embodiment of the present invention a vehicle seat assembly is provided. The vehicle seat assembly includes a seat bottom and a seat back. A load floor panel is associated with the seat assembly. The seat back is pivotally coupled to the seat bottom and has first and second types of retaining features. The load floor panel has first and second types of attachment features. The first and second types of retaining features engage the first and second types attachment features, respectively, when the load floor panel is in a stored position.

In at least one additional embodiment of the present invention a vehicle seat assembly is provided. The vehicle seat assembly includes a seat bottom, a seat back disposed adjacent to the seat bottom, and a load floor panel. The seat back has a back surface that includes a first retaining feature. The load floor panel has a first attachment feature. The first retaining feature engages the first attachment feature and the load floor panel covers at least a portion of the seat back and seat bottom when the load floor panel is in a stored position. The first retaining feature is spaced apart from the first attachment feature when the load floor panel is in a cover position.

### BRIEF DESCRIPTION OF THE DRAWINGS

FIG. 1 is a perspective view of a portion of a vehicle having a seat assembly and a load floor panel.

FIG. 2 is a section view along section line 2-2 of FIG. 1 depicting the load floor panel disposed in a stored position.

FIG. 3 is a section view depicting the load floor panel in a cover position.

FIG. 4 is a magnified section view of an exemplary latch mechanism.

### DETAILED DESCRIPTION

Detailed embodiments of the present invention are disclosed herein; however, it is to be understood that the disclosed embodiments are merely exemplary of the invention that may be embodied in various and alternative forms. The figures are not necessarily to scale, some features may be exaggerated or minimized to show details of particular components. Therefore, specific structural and functional details disclosed herein are not to be interpreted as limiting, but merely as a representative basis for the claims and/or as a representative basis for teaching one skilled in the art to variously employ the present invention.

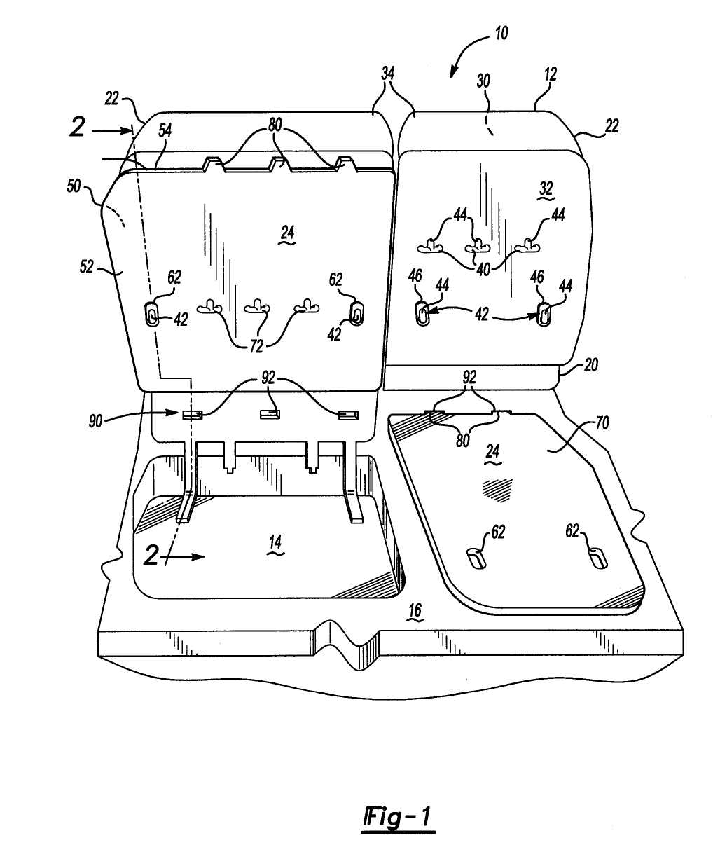

Referring to FIG. 1, a portion of a vehicle 10 is shown. The vehicle 10 may be of any suitable type, such as a motor vehicle. In at least one embodiment of the present invention, the vehicle 10 may include at least one seat assembly 12 and a storage compartment 14. The storage compartment 14 may be provided in a floor 16 of the vehicle 10 in one or more embodiments of the present invention.

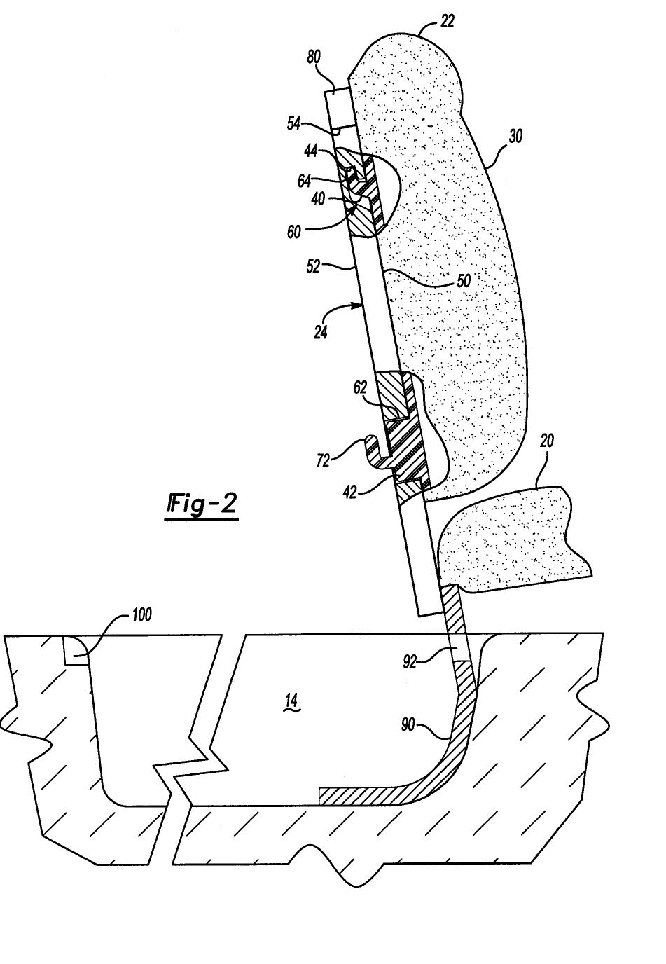

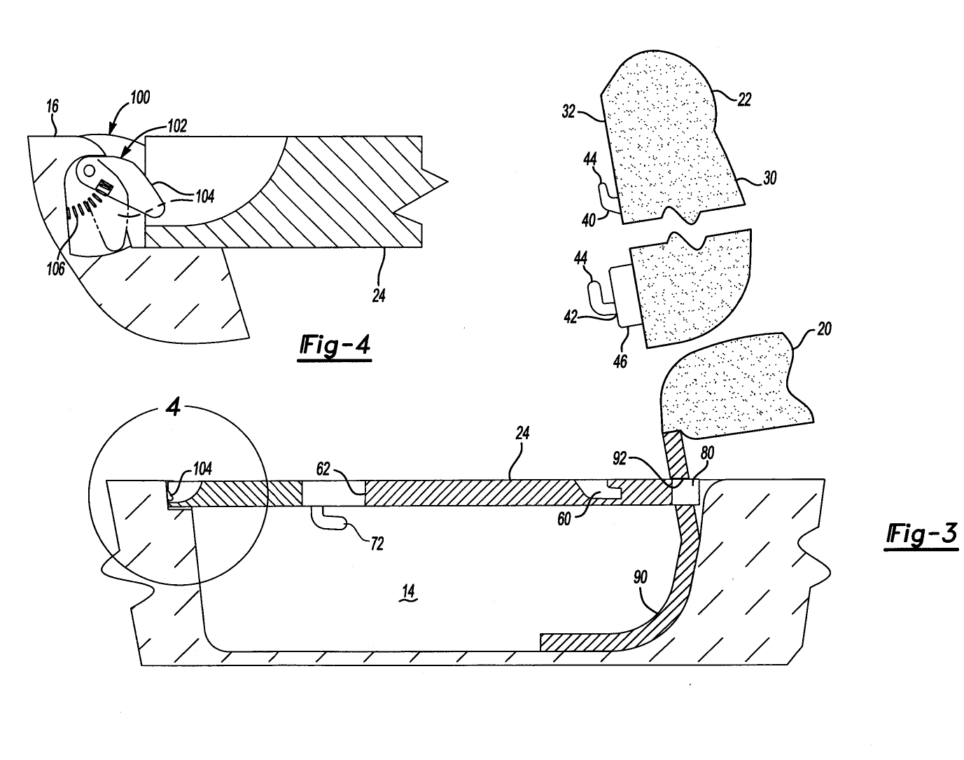

The seat assembly 12 may be disposed in a passenger compartment of the vehicle 10. The seat assembly 12 may include a seat bottom 20 and a seat back 22. Moreover, a load floor panel 24 may be associated with the seat assembly 12 as will be described in more detail below. The load floor panel 24 may be moveable between a stored position and a cover position. In the stored position as shown in the left side of FIG. 1 and in FIG. 2, the load floor panel 24 may be disposed adjacent to the seat back 22. In the cover position as shown in the right side of FIG. 1 and in FIG. 3, the load floor panel 24 may be completely detached from and may be spaced apart from the seat back 22 and positioned to cover the storage compartment 14.

The seat bottom 20 may be configured to receive a seat occupant. The seat bottom 20 may be removably, pivotally, moveably, or fixedly coupled to the vehicle 10 in various embodiments of the present invention.

The seat back 22 may be coupled to the seat bottom 20. In addition, the seat back 22 may include a front surface 30, a back surface 32, and an upper surface 34. The front surface 30 may be configured to receive a seat occupant. The back surface 32 may generally be disposed opposite the front surface 30 and may have any suitable configuration. For example, the back surface 32 may be configured as a polymeric panel that may wrap around one or more sides of the seat back 22. Alternatively, the back surface 32 may be at least partially defined by a seat cover made of any suitable material, such as fabric, leather, vinyl, or combinations thereof in one or more embodiments of the present invention.

The back surface 32 may include at least one retaining feature. The retaining feature may have any suitable configuration, such as a male configuration, female configuration, or combinations thereof. In addition, the retaining feature may be provided as part of a hook and loop fastener like Velcro®. In at least one embodiment, first and second retaining features 40,42 may be provided. The first and second retaining features 40,42 may be adapted to engage the load floor panel 24 as will be discussed in more detail below. The first retaining features 40 may be generally disposed above and spaced apart the second retaining features 42 to provide distributed points of engagement.

The first and/or second retaining features 40,42 may be configured to include a hook portion 44. The hook portion 44 may extend from an associated retaining feature and may be configured to engage or receive various items. For instance, a hook portion 44 may receive the load floor panel 24 when the load floor panel 24 is disposed in a stored position. Moreover, the hook portion 44 may be available to receive another item, such as a bag or cargo net, when the load floor panel 24 is not disposed in the stored position.

In at least one embodiment, the first and/or second retaining features 40,42 may extend from the back surface 32 and include a perimeter surface 46. As least a portion of the perimeter surface 46 may engage an associated portion of the load floor panel 24 to help locate the load floor panel 24 with respect to the seat back 32. As such, the perimeter surface 46 may help align the load floor panel 24 with one or more retaining features 40,42 on the seat assembly 12 to facilitate storage. In addition, by helping align the load floor panel 24 the perimeter surface 46 may aid in coupling a retaining feature that may not be readily visible when the load floor panel 24 is being disposed in the stored position.

The load floor panel 24 may have any suitable configuration. For example, the load floor panel 24 may be generally planar or include a generally planar surface that may be generally level with the vehicle floor 16 when the load floor panel 24 conceals the storage compartment 14. The load floor panel 24 may also be completely detachable from the seat assembly 12 to eliminate the cost and complexity of retaining straps or tethering features.

The load floor panel 24 may be made of any suitable material or materials, such as a polymeric material, and may be fabricated using any suitable manufacturing techniques, such as blow molding, compression molding, or injection molding. In at least one embodiment, the load floor panel 24 may include one or more chambers that may be unfilled, partially filled, and/or completely filled with a core or filling material. In addition, the load floor panel 24 may be provided with or without reinforcement features, such as integrally formed ribs or a stiffening component like a rod. As such, the configuration of the load floor panel 24 may help stiffen the load floor panel 24 to resist buckling or deformation.

Referring to FIGS. 1-3, the load floor panel 24 may include a plurality of surfaces, such as a first surface 50, a second surface 52, and one or more end surfaces 54.

The first surface 50 may be configured to face the seat assembly 12 when the load floor panel 24 is in the stored position. The first surface 50 may have any suitable configuration. For instance, at least a portion of the first surface 50 may be shaped to generally follow the contour of the back surface 32 of the seat back 22 to facilitate coupling to the seat back 22 and/or reduce package space. In at least one embodiment, the first surface 50 may be generally planar.

The first surface 50 may include one or more attachment features that may be associated with a retaining feature on the seat assembly 12. For example, first and second attachment features 60,62 may be provided that are adapted to engage the first and second retaining features 40,42, respectively.

The first and second attachment features 60,62 may have any suitable configuration that may be compatible with one or more associated retaining features. For instance, the first and/or second attachment features may be configured as part of a hook and loop fastener or have a male configuration, female configuration, or combinations thereof.

In at least one embodiment, the first attachment feature 60 may be configured as an aperture or blind hole that receives an associated first retaining feature 40. Moreover, the first attachment feature 60 may include a hook receiving portion 64 that receives a hook portion 44. The hook receiving portion 64 may extend within the load floor panel 24 and may cooperate with the hook portion 44 to inhibit movement of the load floor panel 24 in one or more directions when the load floor panel 24 is disposed in the stored position.

In at least one embodiment, the second attachment feature 62 may be configured to receive the second retaining feature 42. Moreover, the second attachment feature 62 may be configured as a through hole that extends between the first and second surfaces 50,52 to provide a visual reference that may facilitate alignment of the second attachment feature 62 with an associated mating feature. Moreover, the second attachment feature 62 may provide an opening that facilitates grasping of the load floor panel 24 to facilitate positioning of the load floor panel 24 and/or removal of the load floor panel 24 from the cover position. The second attachment feature 62 may be disposed proximate or adjacent to the perimeter surface 46 of the second retaining feature 42 to help align the load floor panel 24.

The second surface 52 may be disposed opposite the first surface 50. The second surface 52 may have any suitable configuration. In at least one embodiment, the second surface 52 may be generally planar. At least a portion of a surface, such as the second surface 52, may include a cover layer 70. In at least one embodiment, the cover layer 70 may cover at least a portion of the load floor panel 24 that faces away from the storage compartment 14 to provide a desirable aesthetic appearance. The cover layer 70 may be made of any suitable material or materials, such as a woven material, non-woven material, and/or polymeric material. In one or more embodiments of the present invention, the cover layer 70 may be omitted from one or more surfaces of the load floor panel 24 to provide a washable or easily cleanable surface.

The second surface 52 may also include one or more retaining features 72. The retaining features 72 may be similar to the retaining features provided with the seat assembly 12. For example, the retaining features 72 may include a hook portion 44 that may be configured to engage or receive various items, such as a bag or cargo net, when the load floor panel 24 is disposed in the stored position.

An end surface 54 may extend between the first and second surfaces 50,52. An end surface 54 may include at least one engagement feature 80. The engagement feature 80 may have any suitable configuration, such as a male configuration, female configuration, or combinations thereof. An end surface 54 having an engagement feature 80 may face in any suitable direction when the load floor panel 24 is disposed in the stored position.

Operation of the load floor panel 24 will now be described in more detail. The load floor panel 24 may be disposed on the seat back 22 such that one or more attachment and retaining features are engaged as described above and shown in FIG. 2. In addition, the engagement features 80 may not extend above the upper surface 34 of the seat back 22 when in the stored position.

The load floor panel 24 may be removed or completely decoupled from the seat back 22 prior to being positioned in the cover position as shown in FIG. 3. In the cover position, at least a portion of the load floor panel 24 may be disposed generally parallel and/or flush with a portion of the vehicle floor 16 disposed adjacent to the storage compartment 14. In addition, the load floor panel 24 may be configured to be reversible (i.e., the first surface 50 may face toward or away from the storage compartment) in one or more embodiments of the present invention.

In at least one embodiment, the engagement feature 80 may engage another component, such as a support structure 90. The support structure 90 may have any suitable configuration. For example, the support structure 90 may be configured as a trim panel that is coupled to the vehicle 10 or the seat assembly 14. In addition, a portion of the support structure 90 may extend into the storage compartment 16 to help distribute load forces and/or provided a desirable aesthetic appearance. In at least one embodiment, the support structure 90 may include a mating feature 92 that engages one or more associated engagement features 80 to help hold the load floor panel 24 in the cover position. For example, a plurality of spaced apart mating features 92 may be provided that each receive an engagement feature 80.

The load floor panel 24 may be at least partially received in a recess 100 in the floor 16. In addition, the floor 16 may include a latch mechanism 102 to help secure the load floor panel 24. An exemplary latch mechanism 102 is shown in FIG. 4. In at least one embodiment, the latch mechanism 102 may include a pawl 104 and a spring 106. The pawl 104 may be moveable between a latched position and an unlatched position shown in phantom in FIG. 4. In the latched position, the pawl 104 may inhibit lifting of the load floor panel 24. The spring 106 may be provided to bias the pawl 104 toward the latched position and may inhibit rattling of the pawl 104.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A vehicle seat assembly comprising:
a seat back having a back surface that includes a first retaining feature; and
a load floor panel having a first attachment feature;
wherein the first retaining feature engages the first attachment feature when the load floor panel is in a stored position and the load floor panel is detached and spaced apart from the seat assembly when the load floor panel is in a cover position.

2. The vehicle seat assembly of claim 1 wherein the load floor panel conceals the first retaining feature when the load floor panel is disposed in the stored position.

3. The vehicle seat assembly of claim 1 wherein the back surface further comprises a second retaining feature and the load floor panel further comprises a second attachment feature that engages the second retaining feature when the load floor panel is in the stored position.

4. The vehicle seat assembly of claim 3 wherein the second retaining feature further comprises a perimeter surface and the second attachment feature engages the perimeter surface.

5. The vehicle seat assembly of claim 3 wherein the second attachment feature is configured as a through hole and the second retaining feature is visible through the through hole when the load floor panel is disposed in the stored position.

6. The vehicle seat assembly of claim 3 wherein the first retaining feature has a different configuration from the second retaining feature and the first attachment feature has a different configuration from the second attachment feature.

7. The vehicle seat assembly of claim 1 wherein the load floor panel further comprises a first surface and a second surface disposed opposite the first surface, wherein the first attachment feature is disposed adjacent to the first surface and the second surface further comprises a retaining feature having a hook portion that faces away from the seat back when the load floor panel is in the stored position.

8. The vehicle seat assembly of claim 1 wherein the load floor panel further comprises an end surface having an engagement feature, wherein the engagement feature is disposed below an upper surface of the seat back when the load floor panel is in the stored position.

9. The vehicle seat assembly of claim 8 further comprising a seat bottom disposed adjacent to the seat back and a support structure disposed proximate the seat bottom and having a mating feature, wherein the engagement feature engages the mating feature when the load floor panel covers a storage compartment.

10. The vehicle seat assembly of claim 9 wherein the mating feature is configured as a slot that receives the engagement feature.

11. The vehicle seat assembly of claim 1 wherein the load floor panel further comprises a first surface and a second surface disposed opposite the first surface, wherein the second surface includes a cover layer.

12. A seat assembly and load floor panel combination, comprising:
a seat bottom;
a seat back pivotally coupled to the seat bottom, the seat back having a back surface that includes first and second types of retaining features; and
a load floor panel associated with the seat back;
wherein the load floor panel further comprises first and second types of attachment features; and
wherein the first and second types of retaining features engage the first and second types of attachment features, respectively, when the load floor panel is in a stored position.

13. The vehicle seat assembly of claim 12 wherein the load floor panel is disengaged and spaced apart from the seat assembly when the load floor panel is in a cover position.

14. The vehicle seat assembly of claim 12 wherein the first type of retaining feature is disposed above the second type of retaining feature.

15. The vehicle seat assembly of claim 12 further comprising a support structure disposed adjacent to the seat back.

16. The vehicle seat assembly of claim 15 wherein at least a portion of the support structure is disposed in a storage compartment.

17. The vehicle seat assembly of claim 12 wherein the first retaining feature further comprises a hook portion that receives the load floor panel.

18. A vehicle seat assembly and load floor panel combination, comprising:
a seat bottom;
a seat back disposed adjacent to the seat bottom, the seat back having a back surface that includes a first retaining feature; and
a load floor panel having a first attachment feature;
wherein the first retaining feature engages the first attachment feature and the load floor panel covers at least a portion of the seat back and seat bottom when the load floor panel is in a stored position and the first retaining feature is spaced apart from the first attachment feature when the load floor panel is in a cover position.

19. The vehicle seat assembly of claim 18 wherein the load floor panel is generally planar.

20. The vehicle seat assembly of claim 18 further comprising first and second load floor panels having different configurations that are disposed on first and second seat backs when in the stored position.
